(19) United States
(12) Patent Application Publication
(10) Pub. No.: US 2011/0035511 A1
(43) Pub. Date: Feb. 10, 2011

(54) Remote Hardware Timestamp-Based Clock Synchronization

(75) Inventor: Daniel Biederman, San Jose, CA (US)

Correspondence Address: Edell, Shapiro, & Finnan, LLC, 1901 Research Blvd, Suite 400, Rockville, MD, 20850, US

(73) Assignee: CISCO TECHNOLOGY, INC., San Jose, CA (US)

(21) Appl. No.: 12/537,686

(22) Filed: Aug. 7, 2009

(51) Int. Cl. G06F 15/16

(52) U.S. Cl. 709/248

(57) ABSTRACT

Techniques are described herein for time synchronization between two devices that communicate with each other across a network, wherein the computations needed for clock synchronization are offloaded from one device to the other, e.g., from a second device (slave) to a first device (master). Messages are received from the first device at a second device. Time of reception values for the messages received at the second device are recorded with respect to a clock of the second device. The second device sends a time value transfer message to the first device or to a third device, wherein the time value transfer message comprises the time of reception values. On the basis of the time of reception values, the first device or the third device computes a clock correction value that represents a time and/or frequency offset between a clock of the first device and the clock of the second device, and sends the time value transfer message to the second device. The second device then updates or adjusts its clock using the clock correction value.

### TECHNICAL FIELD

The present disclosure relates to synchronizing the timing between two devices that are in communication across a network.

### BACKGROUND

There are many applications where two devices communicate with each other across a network to perform various functions. In order to perform those functions, the timing references (e.g., clocks) of the two devices need to be synchronized. There are technologies available to facilitate this timing synchronization. One example of such a technology is the IEEE 1588 standard. This and other timing synchronization protocols require rather complex computations, such as 64-bit arithmetic and/or floating point arithmetic computations.

However, in many real-world deployments, devices are designed with relatively low complexity/capability microprocessors or microcontrollers, such as 16-bit microcontrollers or smaller. These devices are designed for relatively simple applications, such as the case with audio-video bridging (AVB) endpoints that present or capture sound samples. There are other applications where device cost reduction is essential. Therefore, adding the capability to perform timing synchronization would dictate the use of a more expensive microcontroller and this is undesirable because it would lead to higher product costs.

### BRIEF DESCRIPTION OF THE DRAWINGS

FIG. 1 is a block diagram showing first and second devices configured to perform a timing synchronization function that minimizes the computational burden on the second device.

FIG. 2 is a flow chart depicting master clock synchronization logic that is executed in the first device to perform the timing synchronization function.

FIG. 3 is a flow chart depicting slave clock synchronization logic that is executed in the second device to perform the timing synchronization function.

FIG. 4 is a ladder flow diagram depicting the exchange of messages between the first device and second device to perform the timing synchronization function according to a first embodiment.

FIG. 5 is a ladder flow diagram depicting the exchange of messages between the first device and second device to perform the timing synchronization function according to a second embodiment.

FIG. 6 is a ladder flow diagram depicting the exchange of messages between the first device and second device to perform the timing synchronization function according to a third embodiment.

FIG. 7 is a block diagram illustrating a configuration where the clock correction computations are made at a third device rather than at the first device.

### DESCRIPTION OF EXAMPLE EMBODIMENTS

Overview

Techniques are described herein for time synchronization between two devices that communicate with each other across a network, wherein the computations needed for clock synchronization are offloaded from one device to the other, e.g., from a second device (slave) to a first device (master). Messages are received from the first device at a second device. Time of reception values for the messages received at the second device are recorded with respect to a clock of the second device. The second device sends a time value transfer message to an other device, e.g., to the first device or to a third device, wherein the time value transfer message comprises the time of reception values. On the basis of the time of reception values, the first device or the third device computes a clock correction value that represents an offset (time and/or frequency) between a clock of the first device and the clock of the second device, and sends the clock correction value to the second device. The second device then updates or adjusts its clock using the clock correction value. Thus, the second device that is remote from the first device synchronizes to the clock of the first device without having to perform the relatively intensive computations for the clock correction value.

### Example Embodiments

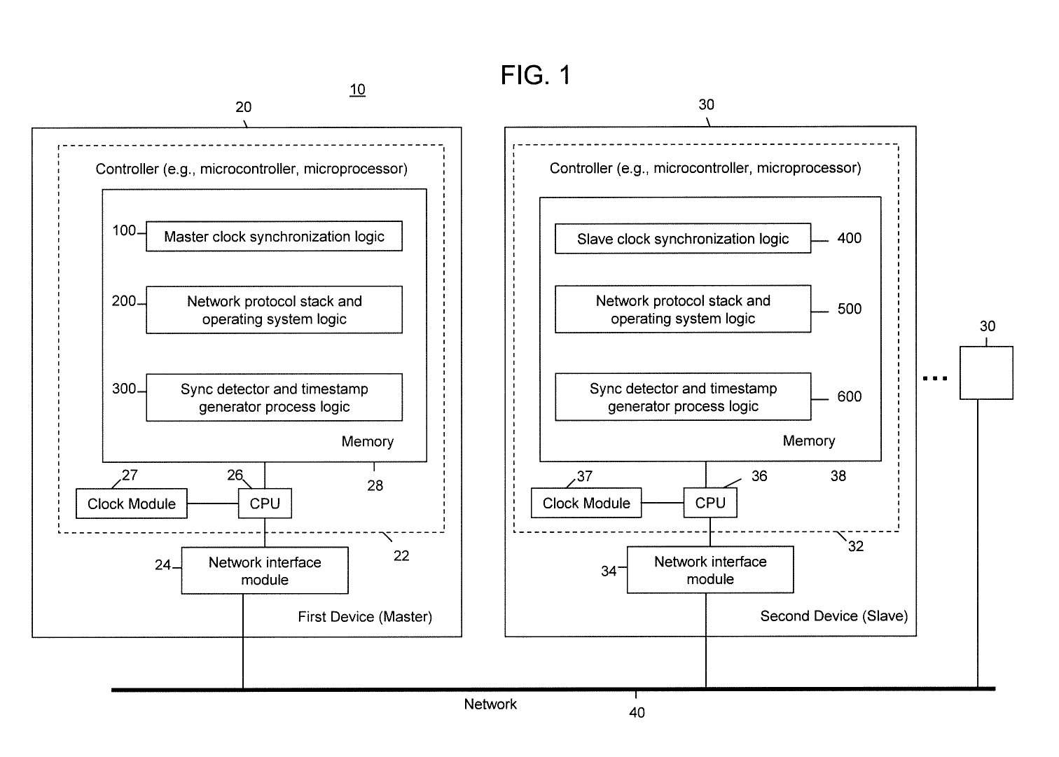

Referring first to FIG. 1, a system 10 is shown in which a first device 20 and a second device 30 communicate with each over a network 40. In this example, the first device 20 is referred to as the “master” and the second device 30 is referred to as the “slave”.

The first and second devices 20 and 30 may be endpoint devices on a network. Several examples of such devices are described hereinafter. However, according to the techniques described herein, the first device 20 and second device 30 are configured so that the second device 30 does not need to perform the mathematical computations necessary to synchronize its timing (e.g., clock) with respect to the timing of the first device 20. Instead, as will become apparent from the following description, the second device 30 offloads the intensive computations necessary for the timing synchronization function to the first device 20. Therefore, the design of the second device 30 can be very low cost because it does not need to perform the intensive computations needed for timing synchronization. The first device 20 is a device that, due to the other functions it is configured to perform, already has the computational capabilities needed for these computations.

FIG. 1 illustrates simplified hardware block diagrams. The first device 20 comprises a controller 22 and a network interface module 24. The controller 22 is, for example, a microcontroller or microprocessor, and comprises a central processing unit (CPU) 26, a clock module 27 and memory 28. The clock module 27 is configured to generate clock values that are used as a timing reference, i.e., “wall time” for operations of the first device 20. For example, the clock module 27 may be a counter that outputs an n-bit word representing a current clock or wall time value at the first device 20. While FIG. 1 shows the clock module 27 within the controller 22, it is to be understood that the clock module 27 may be a separate integrated circuit chip that generates the clock values for use by the controller 22 and network interface module 24. Furthermore, the clock module 27 may reside within the network interface module 24, or separate clock modules may be provided for the controller 22 and the network interface module 24. The network interface module 24 provides the physical layer processing of packets to and from the network 40. For example, the network interface module may be an Ethernet controller. Further still, the clock module 27 may be implemented as software executed by the CPU 26 to keep track of time in the first device 20.

The memory 28 is, for example, a tangible processor readable memory medium, and is encoded with or otherwise stores instructions for several software programs, including master clock synchronization logic 100, network protocol stack and operating system logic 200 and sync detector and timestamp generator process logic 300. The CPU executes these software programs to perform the functions described herein. There may also be a clock process logic stored in the memory 28 to perform the function of the clock module 27 as described above.

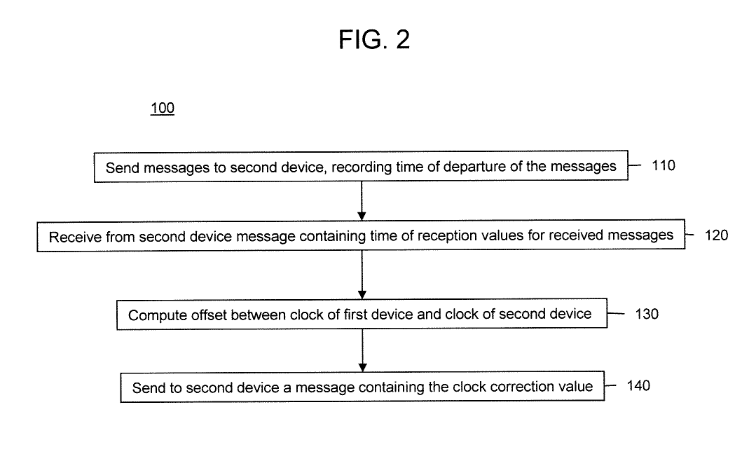

In particular, the master clock synchronization logic 100 is the core logic executed by the CPU to provide the master clock synchronization functions described hereinafter in conjunction with FIGS. 2 and 4-6. The network protocol stack and operating system logic 200 provides higher level network communication control functions. The sync detector and timestamp generator process logic 300 generates a timestamp to represent time of occurrence (either time of departure or time of reception) of packets either transmitted or received, with respect to a clock value (wall time) generated by the clock module 27. The timestamps are clock values used to represent time of departure values and time of reception values of packets (messages) exchanged between the first and second devices 20 and 30 for purposes of the timing synchronization as will become apparent from the following description.

Similarly, the second device 30 comprises a controller 32 and a network interface module 34. The controller 32 is, for example, a microcontroller or microprocessor, and comprises a CPU 36, a clock module 37 and memory 38. The clock module 37 is configured to generate clock values that are used a timing reference, i.e., wall time, for operations of the second device 30. While FIG. 1 shows the clock module 37 within the controller 32, it is to be understood that the clock module 37 may be a separate integrated circuit chip that generates the clock values for use by the controller 32 and network interface module 34. The clock module 37 may reside within the network interface module 34, or separate clock modules may be provided for the controller 32 and the network interface module 34. The network interface module 34, is for example, an Ethernet controller, and provides the physical layer processing of packets to and from the network 40. Moreover, the clock module 37 may be implemented by software executed by the CPU 36.

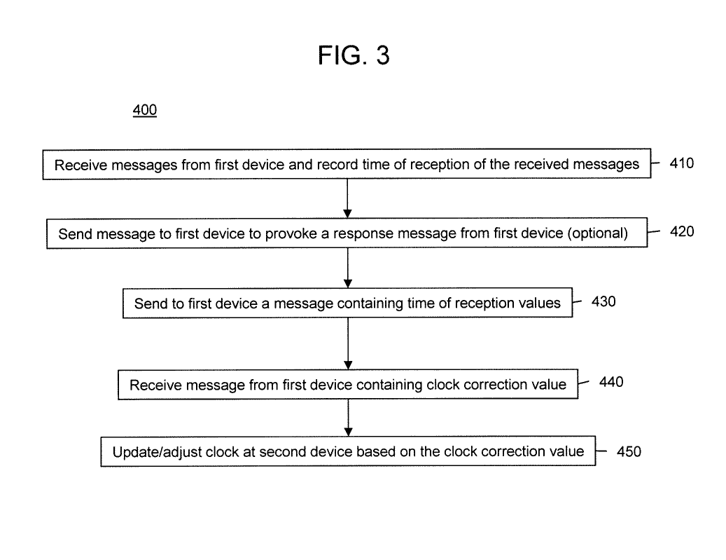

The memory 38 is, for example, a processor readable tangible memory medium, and is encoded with or otherwise stores instructions for several software programs, including slave clock synchronization logic 400, network protocol stack and operating system logic 500 and sync detector and timestamp generator process logic 500. The CPU 36 executes these software programs to perform the functions described herein. In particular, the slave clock synchronization logic 400 is the core logic executed by the CPU 36 to provide the slave clock synchronization functions described hereinafter in conjunction with FIGS. 3-6. The network protocol stack and operating system logic 500 and sync detector and timestamp generator process logic 600 provide functions similar to that of the network protocol stack and operating system logic 200 and sync detector and timestamp generator process logic 300 of the first device 20, described above.

The slave clock synchronization logic 400 is configured to allow the second device 30 to offload to the master clock synchronization logic 100 in the first device the intensive computations needed to determine an offset (time and/or frequency) between the clock of the first device 20 and the clock of the second device 30. It is possible that the clock of the second device 30 may become out of sync or offset with respect to the clock of the first device 30 both in time (wall time) and/or in frequency (how fast the clock of the second device 30 counts with respect to the clock of the first device 20). The first device 20 computes a clock correction value representing this (time and/or frequency) offset and sends it to the second device 30. The second device 30 uses the clock correction value to adjust for the time and/or frequency offset and thereby become synchronized to the clock of the first device 20. Since the second device 30 does not perform these intensive computations, the processing capability of the controller 32 needed for the second device 30 can be minimal and thus the cost of the second device 30 reduced.

The second device 30 may be embodied by a relatively “lightweight” endpoint device that does not require advanced microprocessors. In some cases, only an 8-bit or 16-bit microprocessor or microcontroller is sufficient for use in the second device. This is particularly advantageous in minimizing the cost of the second device 30, for example, in radio frequency identification (RFID) sensors, other industrial Ethernet applications, as well as Internet Protocol (IP) based microphones or speakers. In addition, these techniques may be useful in devices such as electrical relays or circuit breakers in a “smart” grid network, where switches or routers are configured as masters, to communicate with the electrical relays or circuit breakers, which are configured as slaves. The electrical relays or circuit breakers therefore require minimal computational capability that in turn reduces their cost. This is particularly desirable if hundreds or even thousands of relays or circuit breakers are deployed in a smart grid network.

On the other hand, the first device (master device) is a device that typically needs relatively substantial computational capability to perform a variety of functions, such as network routing or switching functions. Therefore, the master device has the computation capability to perform the clock correction value computation described herein. The master device is better suited for this computation and the slave devices can be designed with minimal computation power, depending on their specific application, and at least for the timing synchronization function, can rely on the master device to perform the necessary computations for time synchronization.

The logic described herein, e.g., the master clock synchronization logic 100 and the slave clock synchronization logic 400, may take any of a variety of forms, so as to be encoded in one or more tangible media for execution. For example, the logic may be in the form of software code instructions stored or otherwise encoded in a computer or processor readable memory medium for execution by a processor to perform the functions described herein, as shown in FIG. 1. In another example, the logic 100 and 400 may be in the form of digital logic gates, a programmable gate array device or other programmable or fixed logic device, configured to perform the functions described herein.

The general operational flow of the timing synchronization process between the first device 20 and the second device 30 is as follows. The second device 30, i.e., the slave, forwards time of reception and/or time of departure values of certain packets/messages sent to or received from the first device 20, to the first device 20, i.e., the master, for computing timing adjustment updates. The first device 20 makes the necessary computations using the time of reception and/or time of departure values received from the second device 30, and sends a message to the second device 30 with a clock correction value. The second device 30 uses the clock correction value to adjust or update its clock, i.e., adjust for a time and/or frequency offset between a clock of the first device 20 and a clock of the second device 30. This process may be repeated on a continuous, periodic or on-demand basis to keep the clock of the second device 30 aligned with the clock of the first device 20. Moreover, as shown in FIG. 1, there may be multiple second devices that operate in a similar manner with respect to the first device 20 so that the first device 20 keeps each of multiple second devices, i.e., slaves, aligned to the master clock. Thus, the first device 20 may serve as a master device with respect to multiple slave devices, without limitation on the number of slave devices it can serve.

While FIG. 1 illustrates that the first device 20 and second device 30 communicate directly with each other over the network 40, it is to be understood that there may be other devices between the first device 20 and second device 30 that forward the messages sent between them. These intermediate devices are referred to as “transparent” devices. Thus, the messages sent by the first device 20 to the second device 30 may pass through one or more transparent devices and likewise the messages sent by the second device 30 to the first device 20 may pass through one or more transparent devices.

Turning now to FIG. 2, a flow chart for the master clock synchronization logic 100 is described. At 110, the first device 20 sends messages to the second device 30, and the sync detector and first device records the time of departure of the messages sent by the first device 20 to the second device 30. The sync detector and timestamp generator process logic 300 in the first device 20 (FIG. 1) generates the timestamps, with respect to the clock of the first device 20, for the outgoing messages and these timestamps serve as the time of departure values that are stored by the controller 22 for at least some of the outgoing messages.

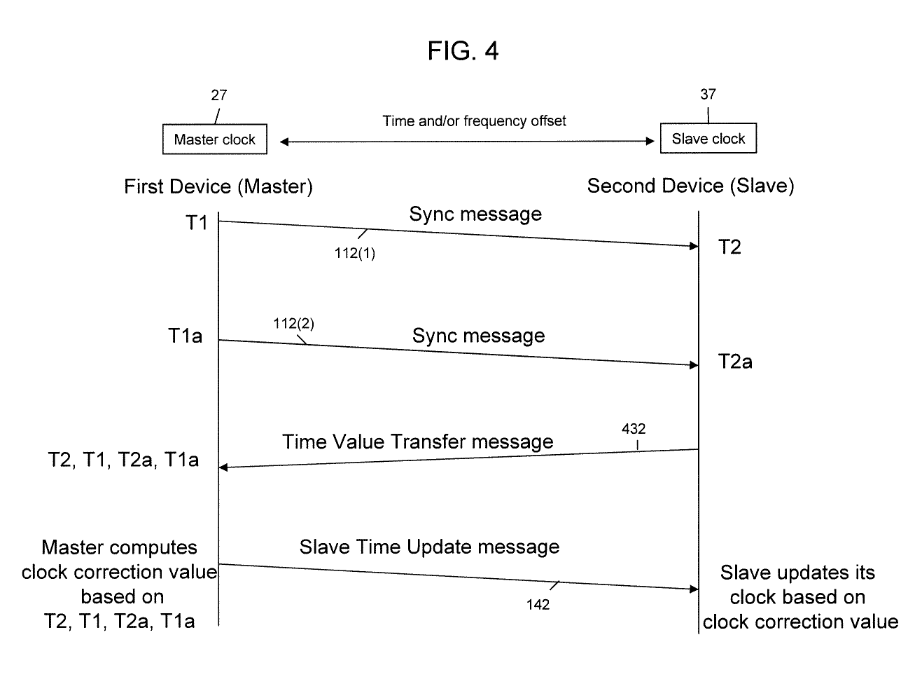

At 110, the time of departure values for the messages with respect to the clock of the first device are recorded. There are several types of outgoing messages that the first device 20 may send, examples of which are described hereinafter in conjunction with FIGS. 4-6. As explained hereinafter, the messages sent at 110 by the first device 20 to the second device 30 are, in one example, messages according the IEEE 1588 standard. At 120, the first device receives a message, referred to herein as a time value transfer message, from the second device. This message comprises time of reception values indicating time of reception of the messages, sent at 110, at the second device, with respect to the clock of the second device.

At 130, the first device 20 computes a clock correction value based on the time of reception values (received in the time value transfer message at 120) and the time of departure values (recorded at 110). The clock correction value represents a time and/or frequency offset between the clock of the first device and the clock of the second device. At 140, the first device 20 sends the clock correction value to the second device 30.

Thus, a master device or apparatus is provided that comprises a network interface module configured to transmit and receive messages over a network, a clock module configured to generate clock values, and a controller coupled to the network interface module and the clock module. The controller is configured to: send messages to an other apparatus, e.g., a slave device; store time of departure values for at least some of the messages in terms of clock values of the clock module; receive a time value transfer message comprising time of reception values indicating times of reception of the messages at the other apparatus with respect a clock of the other apparatus; compute a clock correction value based on the time of reception values and the time of departure values, wherein the clock correction value represents an offset (time and/or frequency) between the clock module and the clock of the other apparatus; and send the clock correction value to the other apparatus. The functions of the controller of the master device described herein may also be embodied as a processor readable memory medium storing or encoded with instructions, that when executed by a processor, cause the processor to perform the functions described herein.

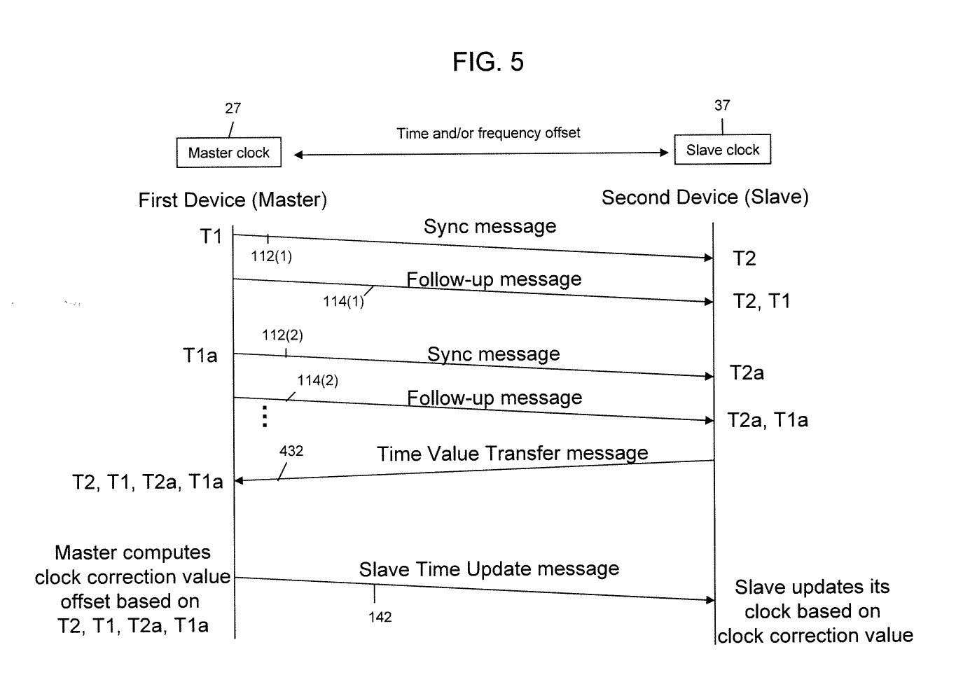

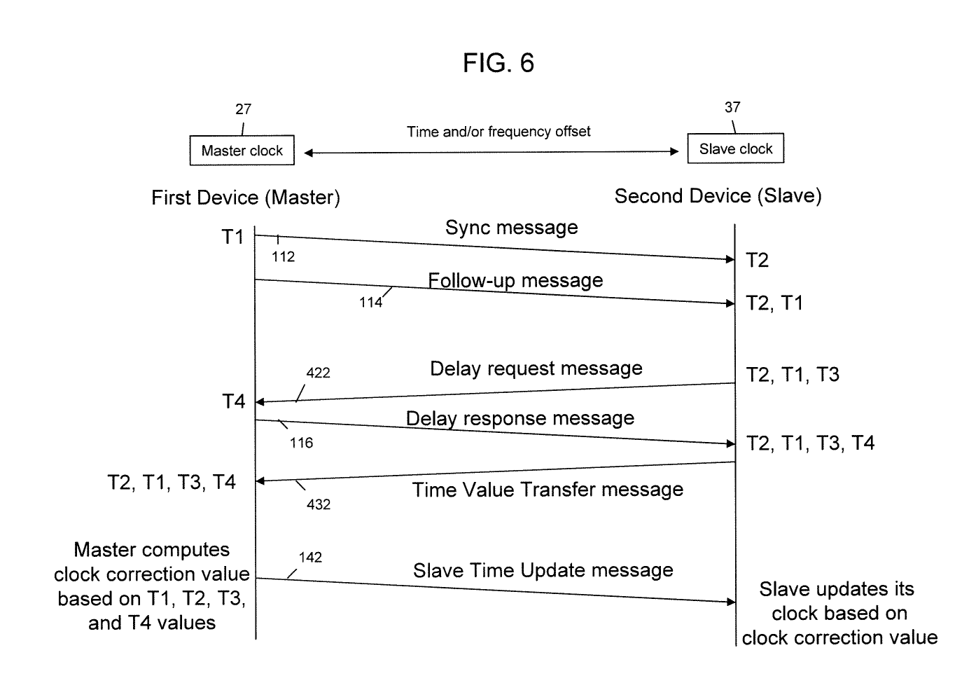

Reference is now made to FIG. 3 for a description of the slave clock synchronization logic 400. At 410, the second device 30 receives messages from the first device 20. The messages received at 410 may be messages according to the IEEE 1588 standard, in one example. These are the messages sent at 110 in the flow chart of FIG. 2. At 410, the second device records time of reception values for the received messages from the first device with respect to the clock of the second device. Function 420 is optional in that there are certain embodiments of the techniques described herein that do not require it, as shown, for example, in FIGS. 4 and 5. Function 420 is applicable to the embodiment of FIG. 6 where the second device sends a message to the first device, which message is configured to provoke a response message from the first device. Also at 420, the second device records the time of departure value of the outgoing message with respect to the clock of the second device. The response message sent by the first device contains a time of departure value indicating when the response message was sent from the first device to the second device.

At 430, the second device generates and sends at least one time value transfer message comprising the time of reception values recorded at 410 and also at 420, if performed.

At 440, the second device receives from the first device the clock correction value computed by the first device (at function 130 in FIG. 2) using the values reported to the first device in the time value transfer message sent at 430. Again, the clock correction value represents a time and/or frequency offset between a clock of the first device and the clock of the second device. At 450, the second device updates its clock based on the clock correction value.

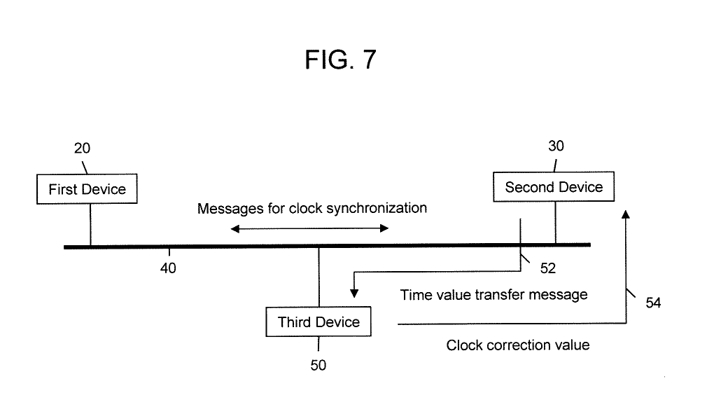

Thus, a slave device or apparatus is provided that comprises a network interface module configured to transmit and receive messages over a network, a clock module configured to generate clock values, and a controller coupled to the network interface module and the clock module. The controller is configured to: receive messages from an other apparatus, e.g., a master device; store time of reception values for the messages received with respect to the clock module; send to the other apparatus a time value transfer message comprising the time of reception values; receive from the other apparatus a clock correction value computed by the other apparatus device on the basis of the time of reception values, wherein the clock correction value represents a time and/or frequency offset between a clock of the other apparatus and the clock module; and adjust the clock module based on the clock correction value. As will become apparent herein, the controller of the slave device is configured to obtain time of departure values contained in messages received from the master device, and to include these time of departure values in the time value transfer message that is sent to the other apparatus. Furthermore, as described hereinafter in conjunction with FIG. 7, the slave device may be configured (at function 430) to offload the computations of the clock correction value to a third device or apparatus, rather than to the master device. In this case, the slave device sends the time value transfer message to the third device (instead of the master device), the third device computes the clock correction value, and the slave device receives the clock correction value from the third device. Thus, function 430 may more generally involve sending the time value transfer message to another apparatus (which may be the master device or a third device). The functions of the controller of the slave device described herein may also be embodied as a processor readable memory medium storing or encoded with instructions, that when executed by a processor, cause the processor to perform the functions described herein.

FIGS. 4-6 illustrate several embodiments for message exchanges using the master clock synchronization logic 100 in the first device 20 and the slave clock synchronization logic 400 in the second device 30. The goal in all of these embodiments is to derive an estimate of the time and/or frequency offset between the master clock shown at reference numeral 27 and slave clock shown at reference numeral 37 in FIGS. 4-6. The following embodiments are made with respect to the IEEE 1588 standard by way of example only. Similar techniques are applicable for use with any master-slave type timing synchronization protocol or standard. The embodiments described herein take advantage of many messages that are part of an existing standard. Devices that are built to comply with the standard can exploit these messages for purposes of generating sufficient information (time of reception values and/or time of departure values) with respect to the sending and receiving of these messages. The devices are configured to generate additional messages, described herein, to offload the more intensive computations to the device that has the greater computational capabilities. In FIGS. 4-6, the functions with reference numerals in the “100's” are functions of the first device (master device) 20 and the functions with reference numerals in the “400's” are functions of the second device (slave device) 30.

Referring now to FIG. 4, a process flow is described for a timing synchronization process according to a first embodiment. This embodiment involves the least amount of messages exchanged between the first device 20 and the second device 30. In particular, in this embodiment, a plurality of messages of a similar type are sent, each of which is separated by a time interval, from the first device 20 to the second device 30. That is, at 112(1), the first device sends a first synchronization (sync) message. In the IEEE 1588 standard for example, a sync message contains an estimate of the time of departure. The first device 20, configured to operate as a master device according to the IEEE 1588 standard (for example), will periodically send these sync messages to another device, e.g., second device 30, to which timing synchronization is to be performed. In the example shown in FIG. 4, the time of departure of the first sync message is T1, with respect to the master clock. The second device receives the first sync message at time T2, with respect to the slave clock, and records or saves the time of reception value T2. At 112(2), the first device 20 sends a second sync message at time T1a with respect to the master clock. The second device 30 receives the second sync message at time T2a with respect to the slave clock and records or saves the time of reception value T2a. Several additional sync messages could be sent, though it is not necessary.

At 432, the second device 30 generates and sends a time value transfer message that contains the time of reception values T2 and T2a (both respect to the slave clock). Using the time of departure values (with respect to the master clock) T1 and T1a and the time of reception values (with respect to the slave clock) T2 and T2a, the first device 20 computes the clock correction value representing the time and/or frequency offset between the slave clock and master clock. This corresponds to the function 130 (FIG. 2) of the first device 20 and this computation is normally performed by the second device 30 according to the IEEE 1588 standard, as one example. However, in order to reduce the computational capabilities of the second device 30, the second device 30 offloads this computation to the first device 20.

The main IEEE 1588 calculations, for example, are associated with time and/or frequency offset. These would normally be done in the slave device, but with the techniques described herein these computations would be performed outside the slave device, that is, either in the master device or an other device. The specific calculations are not described herein as they are fully described in the IEEE 1588 specification documents. There are also algorithms in the IEEE 1588 standard, for example, to select how to adjust the time and/or frequency offset that is totally dependent on the specific hardware, such as averaging values over numerous samples, e.g., 4, 8, 16, 32 or even 64 samples before computing a correction value. Other calculations may also be developed hereinafter.

At 142, the first device 20 sends a slave time update message containing the clock correction value to the second device 30. The second device 30 uses the clock correction value contained in the slave time update message to update or adjusts its clock. For example, the first device 20 may compute the clock correction value to be +25 μsec, indicating that the slave clock is ahead of the 25 μsec. The second device 30 therefore would adjust for this by adjusting its clock module based on the values sent by the first device 20. For example, if the clock module in the second device 30 is a 64-bit counter, the first device 20 could send a course adjustment that would force that 64-bit value to be changed. Similarly, the first device 20 may send a fine adjustment to the second device 30 that adjusts the frequency of the counter, for example, by adjusting an addend value.

The messages sent at 432 and 142 are not messages required by the IEEE 1588 standard, for example. They are additional messages that the master clock synchronization logic 100 and slave clock synchronization logic 400 are configured to generate and send. Nevertheless, an advantage of the embodiment depicted in FIG. 4 is that it uses a minimal number of packet or message exchanges between the first device 20 and the second device 30.

FIG. 5 illustrates another embodiment. In this embodiment, the first device 20 sends a plurality of pairs of messages, each pair comprising a first message followed thereafter by a second message, wherein the second message is configured to contain information indicating a time of departure of the preceding first message from the first device. The second device 30 records for each pair of messages, a time of reception value for the first message and a time of departure value for the first message (from the first device) contained in the second message. After two or more pairs of messages, the second device sends the time value transfer message comprising the time of reception value of the first message and time of departure value of the first message, for each pair of messages.

For example, in the context of the IEEE 15888 standard, the first message is a sync message and the second message is a follow-up message. Again, a device configured to operate as a master device in the IEEE 1588 standard, for example, sends a follow-up message a short period of time after a sync message. Thus, a follow-up message is always associated with a preceding sync message. The follow-up message comprises a precise sending time (measured as close to the physical layer of the network, that is, at the network interface module) as possible of the sync message. Thus, whereas the sync message may contain an estimated sending time of when the sync message is sent, the follow-up message contains a much more precise sending time of when the sync message is sent, again, with respect to the master clock.

At 112(1), the first device 20 sends a first sync message followed thereafter by a first follow-up message at 114(1). The second device receives the first sync message at time T2 with respect to the slave clock and records or saves the time of reception value T2. The second device receives the first follow-up message 114(1) which contains a more precise estimate of the time of departure T1 of the first sync message 112(1). The second device records the time of departure value T1 for the first sync message.

A similar process is repeated for the next sync/follow-up message pair shown at 112(2) and 114(2). The second device receives the second sync message 112(2) at time T2a with respect to the slave clock and records the time of reception value T2a. The second device receives the second follow-up message 114(2) that contains a more precise estimate of the time of departure T1a of the second sync message 112(2). The second device stores the time of departure T1a for the second sync message. This process of receiving pairs of sync/follow-up messages is repeated and additional samples may be stored at the second device. However, in general, samples for at least two pairs of sync/follow-up messages are needed.

At 432, the second device sends a time value transfer message containing the recorded time of departure values T1 and T1a of the first and second sync messages and the recorded time of reception values T2 and T2a of the first and second sync messages. The first device then computes the clock correction value from these values and at 142 sends a slave time update message to the second device 30. The second device then updates its clock using the clock correction value.

FIG. 6 illustrates still another embodiment. This embodiment uses the message pair (first message followed by second message, e.g., sync message and follow-up message) described above in connection with FIG. 5, and another two additional messages: a request message from the second device to the first device and a response message from the first device to the second device. For example, according to the IEEE 1588 standard, a delay request message is generated and sent by a slave device. The delay request message is configured to cause the master device, upon reception, to send a delay response message that is configured to contain information indicating a time of reception value representing time of reception of the delay request message from the salve device. The slave device measures and records the time of departure of the delay request message. When a master device receives the delay request message, it records the time of reception of it. The master device generates and sends a delay response message in response to receipt of a delay request message from a slave device. As indicated above, the delay response message is configured to contain the time of reception at the master device, with respect to the master clock, of the preceding delay request message. The delay request and delay response messages were designed in the IEEE 1588 standard, for example, to allow for a computation of the delay associated with the link (e.g., wire or other medium such as air, optical, etc.) between the master device and the slave device. The second device records the time of reception value for the first message (sync message), the time of departure value for the first message (sync message) contained in the second message (follow-up message), a time of departure value of the request message and the time of reception value of the request message and sends those values in the time value transfer message to the first device.

The delay request/delay response messages are exploited in accordance with the techniques described herein as follows. At 112, the first device 20 sends a sync message and the second device receives the sync message at time T2 with respect to the slave clock. The first device records/saves the time of reception value T2. At 114, the first device 20 sends a follow-up message (containing the time of departure value T1) to the second device 30 and the second device stores the time of departure value T1 of the sync message.

At 422, the second device 30 sends a delay request message to the first device 20. The second device records the time of departure T3 of the delay request message. The first device 20 receives the delay request message at time T4 and at 116 sends to the second device 30 a delay response message containing the time of reception value T4 of the delay request message. Thus, upon receiving the delay response message, the second device has time of reception value T2 of the sync message, time of departure value of the sync message, time of departure value of the delay request message and time of reception value of the delay request message. At 432, the second device 30 sends to the first device 20 a time value transfer message containing these values. The first device 20 computes the clock correction value from these values and at 142 sends a slave time update message containing the clock correction value to the second device 30. The second device 30 updates it clock using the clock correction value.

The master device can communicate with each of a plurality of slave devices to synchronize the clocks of each of the slave devices by communicating, as described above, separately with each slave device to obtain the necessary time values to compute the clock correction value between the master clock and the slave clock for each slave device.

FIG. 7 illustrates a variation to the concepts described herein where the computations that are made to produce the clock correction value are performed by a third device 50 that is not the master or the slave. For example, the third device 50 is a neighboring switch device is connected to the same network as the first device 20 and second device 30. The third device 50 may have a similar block diagram configuration as the first and second devices shown in FIG. 1. The third device 50 may be referred to as a time correction server apparatus. The first device 20 and the second device 30 exchanges the messages as described above in any of the embodiments of FIGS. 4-6, but the second device 30 sends the time value transfer message to the third device 50 instead of to the first device 20 as shown at 52. The third device 50 computes the clock correction value using the time of reception and/or time of departure values in the time value transfer message and sends the clock correction value to the second device 30 as shown at 54. The second device 30 then adjusts its clock using the clock correction value computed by the third device 50. Furthermore, the third device 50 computes the clock correction value such that the delays in the transparent clock switch have minimal affect on synchronization between the first device 20 and the second device 30. Thus, in this variation, function 430 of the slave clock synchronization logic 400 involves sending the time value transfer message to a third device, and function 440 involves receiving the clock correction value (computed by the third device) from the third device. While only a single slave device (second device 30) is shown in FIG. 7, it should be understood that third device 50 may serve as a time correction server for an unlimited number of slave devices.

Although the techniques are illustrated and described herein as embodied in one or more specific examples, it is nevertheless not intended to be limited to the details shown, since various modifications and structural changes may be made therein without departing from the scope of the and range of equivalents of the claims.

What is claimed is:

1. A method comprising:
receiving messages from a first device at a second device;
recording time of reception values for the messages received at the second device with respect to a clock of the second device;
sending from the second device to an other device a time value transfer message comprising the time of reception values;
receiving at the second device from the other device a clock correction value computed by the other device on the basis of the time of reception values, wherein the clock correction value represents an offset between a clock of the first device and the clock of the second device; and
updating the clock of the second device based on the clock correction value.

2. The method of claim 1, wherein sending comprises sending the time value transfer message to the first device, and wherein receiving the clock correction value comprises receiving the clock correction value from the first device.

3. The method of claim 1, wherein sending comprises sending the time value transfer message to a third device, and wherein receiving the clock correction value comprises receiving the clock correction value from the third device.

4. The method of claim 1, wherein receiving message comprises receiving a plurality of pairs of messages, each pair comprising a first message followed thereafter by a second message, wherein the second message is configured to contain information indicating a time of departure of the preceding first message from the first device, and wherein recording comprises recording, for each pair of messages, a time of reception value for the first message and a time of departure value for the first message contained in the second message, and wherein sending comprises sending the time value transfer message comprising the time of reception value and time of departure value for the first message in each pair of messages.

5. The method of claim 4, wherein the first message is a synchronization message and the second message is a follow-up message, both according to the IEEE 1588 standard.

6. The method of claim 1, wherein receiving comprises receiving a first message followed thereafter by a second message, wherein the second message is configured to contain information indicating a time of departure value for the preceding first message, and further comprising sending a request message from the second device to the first device, wherein the request message is configured to cause the first device to send a response message that is configured to contain information indicating a time of reception value representing time of reception of the request message from the second device at the first device with respect to the clock of the first device, wherein receiving further comprises receiving at the second device the response message from the first device, and wherein recording comprises recording a time of reception value for the first message, the time of departure value for the first message contained in the second message, a time of departure value of the request message and the time of reception value of the request message, and wherein sending the time value transfer message comprises sending the time value transfer message comprising the time of reception value for the first message, the time of departure value for the first message, the time of departure value of the request message and the time of departure value of the response message.

7. The method of claim 6, wherein the first message is a synchronization message, the second message is a follow-up message, the request message is a delay request message and the response message is a delay response message, all according to the IEEE 1588 standard.

8. The method of claim 1, wherein receiving messages comprises receiving a plurality of synchronization messages from the first device and wherein recording comprises recording time of reception values for each of the synchronization messages, and wherein sending comprises sending the time value transfer message comprising the time of reception values for each of the synchronization messages.

9. A method comprising:
sending messages from a first device to a second device;
recording time of departure values for at least some of the messages with respect to a clock of the first device;
receiving at the first device a time value transfer message comprising time of reception values indicating times of reception of the messages at the second device with respect to a clock of the second device;
computing a clock correction value based on the time of reception values and the time of departure values, wherein the clock correction value represents an offset between the clock of the first device and the clock of the second device; and
sending the clock correction value from the first device to the second device.

10. The method of claim 9, wherein sending messages comprises sending a plurality of pairs of messages, each pair comprising a first message followed thereafter by a second message, wherein the second message is configured to contain information indicating a time of departure value for the preceding first message, and wherein receiving the time value transfer message comprises receiving the time value transfer message containing the time of reception value for the first message and the time of departure value for the first message for each pair of messages, and wherein computing the clock correction value is based on the time of reception value for the first message and the time of departure value for the first message for each pair of messages.

11. The method of claim 10, wherein the first message is a synchronization message and the second message is a follow-up message, both are according to the IEEE 1588 standard.

12. The method of claim 10, wherein the second message contains the time of departure value for the first message which is a more precise indication of the time of departure of the first message from the first device than an estimated time of departure of the first message obtained at a time of sending of the first message.

13. The method of claim 10, wherein sending comprises sending a pair of messages comprising a first message followed thereafter by a second message, wherein the second message is configured to contain information indicating a time of departure value for the preceding first message, and further comprising receiving a request message from the second device at the first device, wherein the request message is configured to cause the first device to send a response message to the second device, wherein the response message is configured to contain information indicating a time of reception value of the request message at the first device, and wherein receiving the time value transfer message comprises receiving the time value transfer message containing the time of reception value for the first message, the time of departure value for the first message, the time of departure value of the request message and the time of reception value of the request message, and wherein computing the clock correction value is based on the time of reception value for the first message, the time of departure value for the first message, the time of departure value of the request message and the reception value of the request message.

14. The method of claim 13, wherein first message is a synchronization message, the second message is a follow-up message, the request message is a delay request message and the response message is a delay response message, all according to the IEEE 1588 standard.

15. The method of claim 9, wherein sending messages comprises sending a plurality of synchronization messages, recording comprises recording time of departure values for each of the synchronization messages, receiving the time value transfer message comprises receiving the time value transfer message containing time of reception values for each of the synchronization messages, and wherein computing the clock correction value is based on the time of reception values for each of the synchronization messages and the time of departure values for each of the synchronization messages.

16. An apparatus comprising:
a network interface module configured to transmit and receive messages over a network;
a clock module configured to generate clock values;
a controller coupled to the network interface module and the clock module, wherein the controller is configured to:
receive messages from a first apparatus;
store time of reception values for the messages received in terms of clock values output by the clock module;
send to an other apparatus a time value transfer message comprising the time of reception values;
receive from the other apparatus a clock correction value computed by the other apparatus device on the basis of the time of reception values, wherein the clock correction value represents an offset between a clock of the first apparatus and the clock module; and
adjust the clock module based on the clock correction value.

17. The apparatus of claim 16, wherein the controller is configured to send the time value transfer message to the first apparatus, and to receive the clock correction value from the first apparatus.

18. The apparatus of claim 16, wherein the controller is configured to send the time value transfer message to a third apparatus, and to receive the clock correction value from the third apparatus.

19. The apparatus of claim 16, wherein the controller is further configured to obtain time of departure values contained in messages received from the first apparatus, and to include the time of departure values in the time value transfer message that is sent to the other apparatus.

20. The apparatus of claim 16, wherein the controller is further configured to generate and send to the first apparatus a request message that is configured to cause the first apparatus to send a response message that is configured to contain information indicating time of reception value representing time of reception of the request message at the first apparatus with respect to the clock of the first apparatus, and wherein the controller is configured to store a time of departure value of the request message with respect to the clock module, and to include in the time value transfer message the time of departure value for the request message and the time of reception value for the request message.

21. An apparatus comprising:
a network interface module configured to transmit and receive messages over a network;
a clock module configured to generate clock values;
a controller coupled to the network interface module and the clock module, wherein the controller is configured to:
send messages to an other apparatus;
store time of departure values for at least some of the messages in terms of clock values output by the clock module;
receive a time value transfer message comprising time of reception values indicating times of reception of the messages at the other apparatus with respect to a clock of the other apparatus;
compute a clock correction value based on the time of reception values and the time of departure values, wherein the clock correction value represents an offset between the clock module and the clock of the other apparatus; and
send the clock correction value to the other apparatus.

22. The apparatus of claim 21, wherein the controller is further configured to send pairs of messages, each pair comprising a first message followed by a second message, wherein the second message is configured to contain a time of departure value representing a time of departure for the first message with respect to the clock module, and wherein the controller is configured to receive the time value transfer message that contains the time of departure value obtained by the other apparatus from the second message.

23. The apparatus of claim 22, wherein the controller computes the clock correction value using the time of departure value included in the time value transfer message that was contained in the second message, and wherein the time of departure value contained in the second message is a more precise indication of the time of departure of the first message than an estimate time of departure of the first message obtained at the time the first message is sent.

24. A processor readable tangible memory medium encoded with instructions that, when executed by a processor, cause the processor to:
receive messages from a first device at a second device;
store time of reception values for the messages received at the second device with respect to a clock of the second device;
send from the second device to an other device a time value transfer message comprising the time of reception values;
receive at the second device from the other device a clock correction value computed by the other device on the basis of the time of reception values, wherein the clock correction value represents an offset between a clock of the first device and the clock of the second device; and
adjust the clock of the second device based on the clock correction value.

25. A processor readable tangible memory medium encoded with instructions that, when executed by a processor, cause the processor to:
send messages from a first device to a second device;
store time of departure values for at least some of the messages with respect to a clock of the first device;
receive at the first device a time value transfer message comprising time of reception values indicating times of reception of the messages at the second device with respect to a clock of the second device;
compute a clock correction value based on the time of reception values and the time of departure values, wherein the clock correction value represents an offset between the clock of the first device and the clock of the second device; and
send the clock correction value from the first device to the second device.
